(19) United States
(12) Patent Application Publication
(10) Pub. No.: US 2020/0377065 A1
(43) Pub. Date: Dec. 3, 2020

(54) BRAKE FORCE MODULATION TO ENABLE STEERING WHEN STATIONARY

(71) Applicant: Caterpillar Inc., Deerfield, IL (US)

(72) Inventors: Timothy D. Schwartz, East Peoria, IL (US); Russell J. Pugh, Chester-Le Street (GB); David R. Wisley, Darlington (GB); James B. McKnight, Champaign, IL (US)

(73) Assignee: Caterpillar Inc., Deerfield, IL (US)

(21) Appl. No.: 16/426,348

(22) Filed: May 30, 2019

(51) Int. Cl. B60T 8/1766; B60T 8/1755

(52) U.S. Cl. CPC B60T 8/1766; B60T 2201/03; B60T 8/17551

(57) ABSTRACT

An articulated work machine includes a frame assembly having a front portion and a rear portion; an articulation joint connecting the front and rear portions and adapted to allow pivotal movement about the articulation joint by the front and rear portions; a plurality of front wheels attached to the front portion and a plurality of rear wheels attached to the rear portion; a brake associated with each of the front wheels and rear wheels; a steering sensor adapted to provide a steering signal from a steering mechanism of the articulated work machine; and a controller adapted to receive the steering signal, and wherein when a braking force is applied to the front and rear wheels when the controller receives the steering signal, the controller produces a signal to modulate the braking force to allow the front portion and rear portion of the machine to articulate without the machine moving forward.

### TECHNICAL FIELD

This disclosure relates to road construction equipment, and more specifically to an articulated machine.

### BACKGROUND

Work machines used at construction sites and other off-road locations are often articulated machines. An articulated machine includes front and rear frames hinged together by an articulation joint for relative pivotal movement. When one of the frames is moved relative to the other, the machine turns.

However, when the articulated machine is stopped because of the brakes being applied, it is difficult to articulate the front and rear frames relative to each other. Thus, if the machine is near an obstacle, it may need difficult back and forth maneuvering to get around the obstacle. U.S. Pat. No. 9,014,921 discusses a vehicle which includes a collision avoidance system with a brake system which permits driver-independent buildup and modulation of braking forces.

### SUMMARY

In an example according to this disclosure, an articulated work machine includes a frame assembly having a front portion and a rear portion; an articulation joint connecting the front and rear portions and adapted to allow pivotal movement about the articulation joint by the front and rear portions; a plurality of front wheels attached to the front portion and a plurality of rear wheels attached to the rear portion; a brake associated with each of the front wheels and rear wheels; a steering sensor adapted to provide a steering signal from a steering mechanism of the articulated work machine; and a controller adapted to receive the steering signal, and wherein when a braking force is applied to the front and rear wheels when the controller receives the steering signal, the controller produces a signal to modulate the braking force to allow the front portion and rear portion of the machine to articulate without the machine moving forward.

In another example, an articulated work machine includes a frame assembly having at least a front portion and a rear portion; an articulation joint connecting the front and rear portions and adapted to allow pivotal movement about the joint by the front and rear portions; a plurality of axles attached the frame assembly, including a front axle supporting the front portion and a rear axle attached to the rear portion; a plurality of front wheels attached to the front axle and a plurality of rear wheels supporting the rear axle; a brake associated with each of the front and rear wheels; a steering sensor adapted to provide a steering signal from a steering mechanism of the articulated work machine; an operator compartment supported by the frame assembly and including the steering mechanism; a body adapted to carry a load and being connected to the frame assembly; an engine for generating torque and being supported by the frame assembly; and a controller adapted to receive the steering signal, and wherein when a braking force is applied to the front and rear wheels when the controller receives the steering signal, the controller produces a signal to modulate the braking force to allow the front portion and rear portion of the machine to articulate without the machine moving forward.

In another example according to the present disclosure, a method of articulating a stationary articulated work machine includes sending a steering signal to a controller when a braking force is applied to wheels of the articulated work machine; the controller modulating a brake force at one or more of the wheels; and articulating a rear portion and a front portion of the articulated work machine without the machine moving forward.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a side view of an articulated machine, in accordance with one embodiment.

FIG. 2 shows a schematic of a hydraulic braking system, in accordance with one embodiment.

FIG. 3 shows schematic of a drivetrain, in accordance with one embodiment.

FIG. 4 shows a side view of an articulated machine, in accordance with one embodiment.

FIG. 5 shows a method of controlling an articulated machine, in accordance with one embodiment.

### DETAILED DESCRIPTION

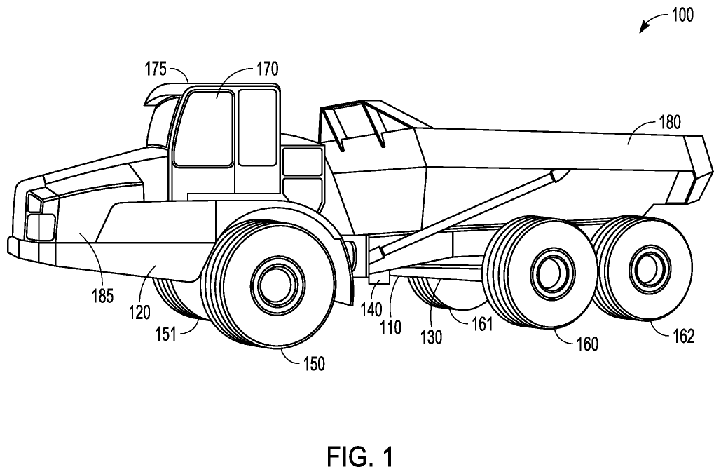

FIG. 1 shows an articulated work machine 100 in accordance with one embodiment. The articulated work machine 100 generally includes a frame assembly 110 having a front portion 120 and a rear portion 130. An articulation joint 140 connects the front and rear portions 120, 130 and is adapted to allow pivotal movement about the articulation joint 140 by the front and rear portion 120, 130. In some examples, the articulation joint 140 can also move back and forth in a known manner perpendicular to a centerline of the machine 100 as the machine articulates, imparting an additional component of motion to the machine's turning dynamics.

The articulated work machine 100 further includes a plurality of front wheels 150, 151 attached to the front portion 120 and a plurality of rear wheels 160-163 attached to the rear portion 130. In this example, the articulated work machine 100 includes an articulated truck, where the front portion 120 includes two wheels 150, 151 and the rear portion 130 includes four wheels 160-163.

The articulated work machine 100 also can include an operator compartment 170 supported by the frame assembly 110 and including the steering mechanism 175, such as a steering wheel. The machine 100 can include body 180 adapted to carry a load and being connected to the frame assembly 110, and an engine 185 for generating torque and being supported by the frame assembly 110.

A problem may arise if an operator needs to articulate the machine 100 without allowing the machine 100 to move forward. For example, if the brakes of the machine 100 are applied it can be very difficult to articulate the machine. Accordingly, as will be described in detail below, the present system allows for various techniques to allow the machine 100 to articulate while remaining stationary.

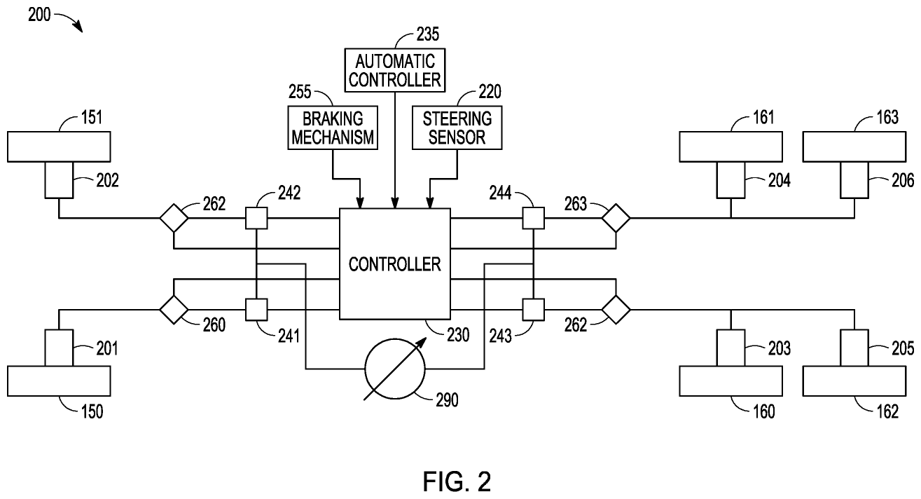

For example, FIG. 2 shows a schematic representation of a portion of a hydraulic braking system 200 of the articulated work machine 100, in accordance with one embodiment. Hydraulic braking system 200 is configured to allow one or more of the brakes of the machine 100 to be modulated, or lessened, while still keeping the machine 100 stationary. Here, the hydraulic braking system 200 includes a central hydraulic pump 290 to pump hydraulic fluid around the system to and from the various components. In this example, there is a hydraulic brake 201-206 associated with each of the front wheels 150, 151 and rear wheels 160-163.

A controller 230 is connected to the hydraulic system 200 to send and receive signals to and from various components. For example, a steering sensor 220 is adapted to receive a steering signal from the steering mechanism 175 (FIG. 1) of the articulated work machine 100 and send a signal to the controller 230. The controller 230 can further receive a signal regarding a braking force being applied from a braking mechanism 255. The controller 230 can be adapted to receive the steeling signal, and if a braking force has been applied to the front and rear wheels 150, 151, 160-163 by the braking mechanism 255, the controller 230 then produces a signal to modulate or lessen the braking force to one or more of the wheels 151, 150, 160-163 so as to allow one or more of the wheels 150, 151, 160-163 to rotate in a manner to allow the front portion 120 and rear portion 130 of the machine 100 to articulate without allowing moving the machine 100 forward.

In this example, the braking mechanism 255 can be manual or automatic. This, the brakes 201-206 can be manually activated by the operator, or the brakes 201-206 can be automatically applied due to an auto-detection system 235 sending a signal to the controller 230 that the brakes are to be applied.

In one example, each of the brakes 201-206 can be controlled by a solenoid 241-244 coupled to the controller 230. When the solenoid receives a current from the controller 230, the solenoid allows hydraulic fluid to flow to the brakes 201-206. However, if a steering signal is received by the controller 230, the controller 230 can reduce a current to one or more of the solenoids 241-244 to modulate the braking force at one or more of the wheels 150, 151, 160-163. This allows one or more wheels to rotate so the machine can articulate without moving forward.

In one example, to modulate the braking force the controller 230 reduces a current to the solenoids 241-244 of the front brakes 201-202 while the rear brakes 203-206 remain fully engaged. This allows the front wheels 150, 151 to be allowed to rotate as the articulation joint 140 rotates the front and rear portions of the machine 100 while the rear brakes remain engaged to keep the machine from moving forward. In another example, the rear brakes 203-206 can be modulated to allow one or more of the rear wheels 16-163 to rotate during articulation while keeping the machine from moving forward.

In one example, to modulate the braking force the controller 230 activates a blocking valve 260-263 to block or reduce hydraulic flow to one or more of the brakes 201-206. In this example, the brakes 201-206 can be manually applied by an operator which is activated by braking mechanism 255. In one example, only the front brakes 201-202 are modulated. This allows the front wheels 150-151 to rotate and the machine 100 articulates while the rear wheels 160-163 remain stationary. However, as noted, in some examples, the rear brakes 203-206 can be modulated to allow one or more of the rear wheels 160-163 to rotate during articulation while keeping the machine from moving forward.

Another technique to allow for modulation of braking force while keeping the machine stationary can be accomplished using a central differential clutch in the drivetrain of machine 100.

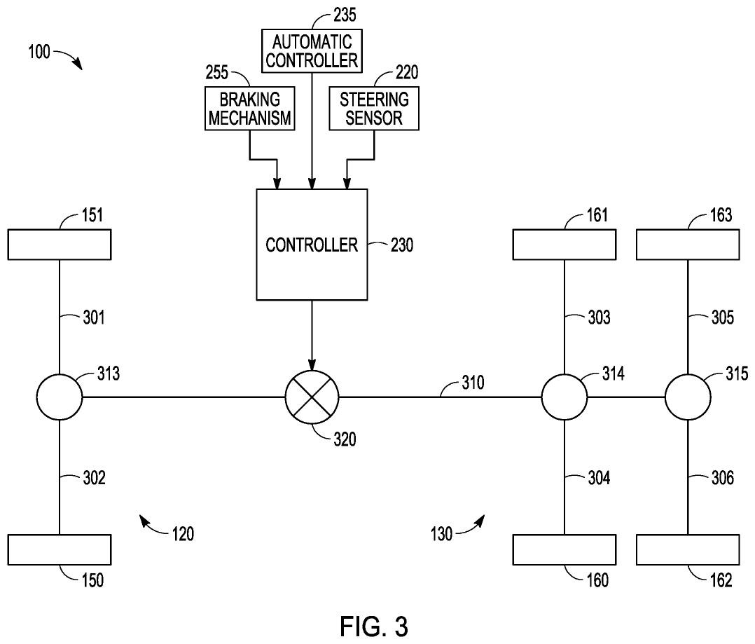

For example, FIG. 3 shows a schematic representation of a drivetrain of the machine 100, in accordance with one embodiment. Here the drivetrain generally includes a plurality of axles 301-306 coupled to the respective wheels 150, 151, 160-163. There can be a plurality of axles 301-306 attached the frame assembly 110, including a front axle 301/302 supporting the front portion 120 and a rear axle 303/304, 305/306 attached to the rear portion 130.

A driveshaft 310 runs longitudinally down the machine 100. Each axle 301-306 includes a respective differential clutch 313-315. There is also a central differential clutch 320 in the driveshaft 310 between the front portion 120 and the rear portion 130 of the machine 100.

The controller 230 can be operatively coupled to the central differential clutch 320 to allow for control over the function of the central differential clutch 320, depending on the various signals received from the braking mechanism 255, the auto-detection system, and the steeling sensor 220 For example, if the brakes have been applied and the controller 230 receives a steering signal from the steering sensor 220, the controller 230 can unlock the central differential clutch 320 between the rear portion 130 and the front portion 120 to allow for the transfer of torque so that the front wheels 150, 151 have a reduced torque and can rotate while the rear wheels 160-163 are fully braked so as to allow the steering effort to be less.

Referring also to FIG. 2, in one example, these methods for allowing articulation can be combined, and to modulate the braking force the controller 230 can reduce a current to one or more of the solenoids 241-244, and/or send a signal to one or more blocking valves 260-263, and/or the controller 230 can unlock the central differential clutch 320 between the rear portion 130 and the front portion 120 so that the steering effort to be less without the machine moving. For example, the front wheels 150, 151 can be allowed to rotate while the rear wheels 160-163 are fully braked to allow for articulation while stationary.

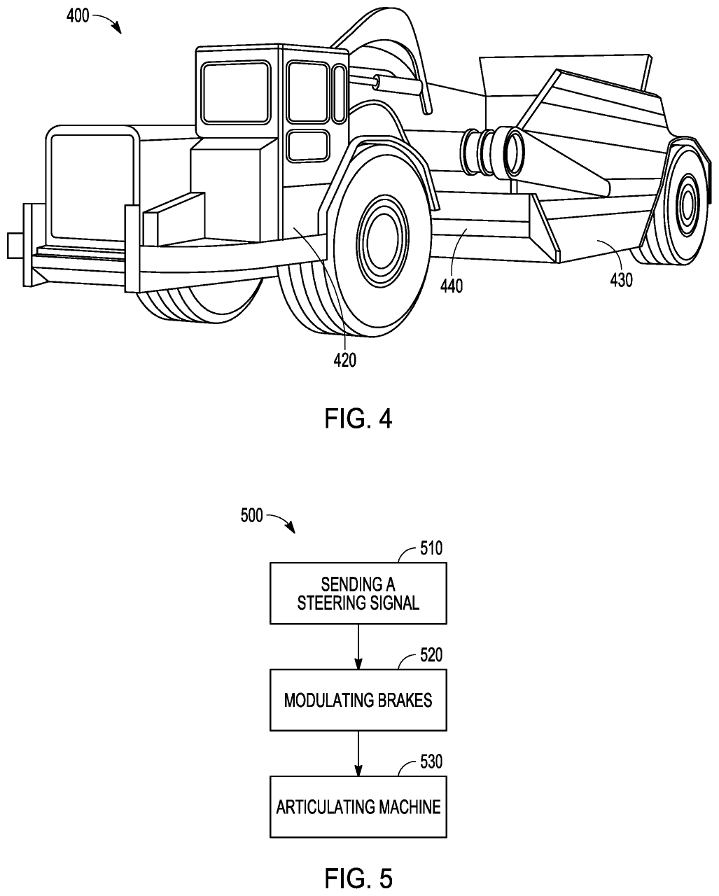

FIG. 4 shows a side view of an articulated machine, in accordance with one embodiment. Here, the articulated work machine includes a wheel tractor scraper 400. The wheel tractor scraper 400 includes a front portion 420 and a rear portion 430 and an articulation joint 440 with two wheels for each of the front and rear portions 420, 430. The above discussion of FIGS. 1-3 also applies to the wheel tractor scraper 400.

### Industrial Applicability

The present system is applicable during many situations in road construction. Again, it is useful for the machine operator to be able to articulate a machine without the machine moving forward, for example if there is an obstacle in front of the machine.

FIG. 5 shows a method 500 of articulating a stationary articulated work machine 500. Here the method will refer to the articulated machine 100 discussed above. In an example the method 500 can include sending a steering signal to a controller 230 when a braking force is applied to wheels of the articulated work machine 100 (510). The method further includes the controller 230 modulating a brake force at one or more of the wheels (520). The method further includes articulating a rear portion 130 and a front portion 120 of the articulated work machine 100 (530).

In one example, each of the brakes can be controlled by the solenoid 241-244 coupled to the controller 230. To modulate the braking force the controller 230 reduces a current to one or more of the solenoids 241-244. In one example, to modulate the braking force the controller 230 can activate the blocking valves 260-263 to block or reduce hydraulic flow to one or more of the brakes.

In one example, the controller 230 can unlock the central differential clutch 320 between the front portion and the rear portion so as to reduce torque to the front portion wheels to allow the machine to articulate without moving forward.

In various examples, the articulation can be allowed when the machine is stopped by an auto-detection system detecting an obstacle. In that case the brakes are applied automatically by the controller. If the controller then receives a steering signal, the control can modulate the braking force to allow the machine to articulate, as discussed above. Likewise, if the operator of the machine has manually applied the brakes, then the controller can modulate the braking force in the techniques described above.

In some examples, the different techniques for providing articulation while keeping the machine stationary can include sending signals to the solenoids to modulate the braking force, activating a blocking valve to reduce hydraulic flow to one or more of the brakes, and/or unlocking the central differential clutch between the front portion and the rear portion to allow the machine to articulate without moving forward.

Various examples are illustrated in the figures and foregoing description. One or more features from one or more of these examples may be combined to form other examples.

The above detailed description is intended to be illustrative, and not restrictive. The scope of the disclosure should, therefore, be determined with references to the appended claims, along with the full scope of equivalents to w such claims are entitled.

What is claimed is:

1. An articulated work machine comprising:
a frame assembly having a front portion and a rear portion;
an articulation joint connecting the front and rear portions and adapted to allow pivotal movement about the articulation joint by the front and rear portions;
a plurality of front wheels attached to the front portion and a plurality of rear wheels attached to the rear portion;
a brake associated with each of the front wheels and rear wheels;
a steering sensor adapted to provide a steering signal from a steering mechanism of the articulated work machine; and
a controller adapted to receive the steering signal, and wherein when a braking force is applied to the front and rear wheels when the controller receives the steering signal, the controller produces a signal to modulate the braking force to allow the front portion and rear portion of the machine to articulate without the machine moving forward.

2. The articulated work machine of claim 1, wherein each of the brakes are hydraulic brakes controlled by a solenoid coupled to the controller, wherein to modulate the braking force the controller reduces a current to one or more of the solenoids.

3. The articulated work machine of claim 2, wherein the brakes are automatically applied due to an auto-detection system.

4. The articulated work machine of claim 1, wherein each of the brakes are hydraulic brakes controlled by a solenoid coupled to the controller, wherein to modulate the braking force the controller reduces a current to the solenoids of the front brakes while the rear brakes remain fully engaged.

5. The articulated work machine of claim 1, wherein each of the brakes are hydraulic brakes, wherein to modulate the braking force the controller applies a blocking valve to block or reduce hydraulic flow to one or more of the brakes.

6. The articulated work machine of claim 5, wherein the brakes are manually applied by an operator.

7. The articulated work machine of claim 5, wherein only the front brakes are modulated.

8. The articulated work machine of claim 1, wherein the controller unlocks a central differential clutch between the rear portion and the front portion so that the front wheels can rotate while the rear wheels are fully braked so as to allow the steering effort to be less.

9. The articulated work machine of claim 1, wherein each of the brakes are hydraulic brakes controlled by a solenoid coupled to the controller, wherein to modulate the braking force the controller reduces a current to one or more of the solenoids, and wherein the controller unlocks a central differential clutch between the rear portion and the front portion so that the front wheels can rotate while the rear wheels are fully braked so as to allow the steeling effort, to be less.

10. The articulated work machine of claim 1, wherein the front portion includes two wheels and the rear portion includes four wheels.

11. An articulated work machine comprising:
a frame assembly having at least a front portion and a rear portion;
an articulation joint connecting the front and rear portions and adapted to allow pivotal movement about the joint by the front and rear portions;
a plurality of axles attached the frame assembly, including a front axle supporting the front portion and a rear axle supporting the rear portion;
a plurality of front wheels attached to the front axle and a plurality of rear wheels attached to the rear axle;
a brake associated with each of the front and rear wheels;
a steering sensor adapted to provide a steering signal from a steering mechanism of the articulated work machine;
an operator compartment supported by the frame assembly and including the steering mechanism;
a body adapted to carry a load and being connected to the frame assembly;
an engine for generating torque and being supported by the frame assembly; and
a controller adapted to receive the steering signal, and wherein when a braking force is applied to the front and rear wheels when the controller receives the steering signal, the controller produces a signal to modulate the braking force to allow the front portion and rear portion of the machine to articulate without the machine moving forward.

12. The articulated work machine of claim 11, wherein each of the brakes are hydraulic brakes controlled by a solenoid coupled to the controller, wherein to modulate the braking force the controller reduces a current to one or more of the solenoids.

13. The articulated work machine of claim 11, wherein each of the brakes are hydraulic brakes, wherein to modulate the braking force the controller applies a blocking valve to block or reduce hydraulic flow to one or more of the brakes.

14. The articulated work machine of claim 11, wherein the controller unlocks a central differential clutch between the rear portion and the front portion so that the front wheels can rotate while the rear wheels are fully braked so as to allow the steering effort to be less.

15. The articulated work machine of claim 11, wherein each of the brakes are hydraulic brakes controlled by a solenoid coupled to the controller, wherein to modulate the braking force the controller reduces a current to one or more of the solenoids, and wherein the controller unlocks a central differential clutch between the rear portion and the front portion so that the front wheels can rotate while the rear wheels are fully braked so as to allow the steering effort to be less machine.

16. The articulated work machine of claim 11, wherein the articulated work machine includes an articulated truck.

17. The articulated work machine of claim 11, wherein the articulated work machine includes a wheel tractor scraper.

18. A method of articulating a stationary articulated work machine, the method comprising:
sending a steering signal to a controller when a braking force is applied to wheels of the articulated work machine;
the controller modulating a brake force at one or more of the wheels; and
articulating a rear portion and a front portion of the articulated work machine without the machine moving forward.

19. The method of claim 18, wherein each of the brakes are hydraulic brakes controlled by a solenoid coupled to the controller, wherein to modulate the braking force the controller reduces a current to one or more of the solenoids.

20. The method of claim 18, wherein each of the brakes are hydraulic brakes, wherein to modulate the braking force the controller applies a blocking valve to block or reduce hydraulic flow to one or more of the brakes.
